(19) United States
(12) Patent Application Publication
(10) Pub. No.: US 2006/0049128 A1
(43) Pub. Date: Mar. 9, 2006

(54) Ventilated baby bottle

(76) Inventor: Fu-Long Lan, Taipei (TW)

Correspondence Address: FU-LONG LAN, P.O. BOX 26-757, TAIPEI, 106, TW

(21) Appl. No.: 10/936,734

(22) Filed: Sep. 9, 2004

(51) Int. Cl. A61J 9/00; A61J 9/04; A61J 11/02

(52) U.S. Cl. 215/11.4; 215/11.5

(57) ABSTRACT

A ventilated baby bottle can balance the pressure inside/outside the baby bottle to avoid a baby suffering from abdominal distention due to excessive ingestion of air during nursing. The ventilated baby bottle has a bottle portion, a nipple, and a peripheral cover. The bottle portion has a ventilated protrusion protruding from the exterior thereof, and a vent hole penetrating through the ventilated protrusion. The nipple is disposed on a top end of the bottle portion. The peripheral cover has two ends; one end is disposed on the bottle portion, and the other end has a sealing cap movably covering the ventilated protrusion. The sealing cap is formed with a sealing post movably inserted in the vent hole.

### BACKGROUND OF THE INVENTION

1. Field of the Invention

The present invention relates to a ventilated baby bottle, and particularly to a baby bottle having a movable ventilation device, which can balance the pressure difference inside/outside the baby bottle while a baby nurses the bottle.

2. Description of the Prior Art

Baby bottle design must consider the problem of pressure balance with environmental atmosphere. A ventilated rubber nipple is provided for balancing the pressure inside/outside the baby bottle, in accord with huge progress in the rubber industry. A ventilated rubber nipple is formed with a plurality of vent holes in a periphery thereof for allowing air flow. When a predetermined pressure difference is created by the baby sucking on the nipple, the outside air flows into the baby bottle.

However, the predetermined pressure difference inside/outside the baby bottle must be reached before outside air flow is forced into the baby bottle. The baby bottle does not reach a real pressure balance. The baby must suck arduously until exceeding the predetermined pressure, and then the outside air is forced in. During the process of nursing, most of the time, the baby bottle is under a negative pressure condition so that the baby sucks must nurse with great effort. This discourages the baby from nursing and also adversely affects the growth of baby teeth. Moreover, the vent holes of a ventilated nipple are adjacent the sucking portion and are covered with milk. The flowing air makes many bubbles, and the baby ingests too much air, resulting in abdominal distention. The vent holes also are very small and formed invisibly between the nipple and the nipple ring. They are difficult to clean, accumulate milk residue, and result in a health problems for the baby.

Therefore, the baby bottle of the prior art still has some inconveniences and disadvantages as followed:

1. It cannot really balance the pressure inside/outside the baby bottle.

2. It easily causes abdominal distention in the baby.

3. It is difficult to clean.

The inventor, after investigation and research, thus provides the present invention of logical designing for improving the above-mentioned imperfections.

### SUMMARY OF THE INVENTION

An object of the present invention is to provide a ventilated baby bottle that produces a real pressure balance, such that a baby does not need to overcome laboriously the pressure difference, and is not discouraged from nursing and does not suffer from excessive abdominal distention and having no appetite for milk.

Another object of the present invention is to provide a ventilated baby bottle with an easily cleaned ventilation structure that does not accumulate milk residue. In order to achieve the above objects, the present invention provides a ventilated baby bottle comprising a bottle portion, a nipple, and a peripheral cover. The bottle portion has a ventilated protrusion protruding outside therefrom, and a vent hole penetrating through the ventilated protrusion. The nipple is disposed on a top end of the bottle portion. The peripheral cover has two ends; one end is disposed on the bottle portion, and the other end has a sealing cap movably covering the ventilated protrusion. The sealing cap is formed with a sealing post movably inserted in the vent hole.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 is a side exploded view of a ventilated baby bottle according to the present invention;

FIG. 2 is a top view of a peripheral cover of the ventilated baby bottle according to the present invention; and

FIG. 3 is a top assembly view of the ventilated baby bottle according to the present invention.

### DESCRIPTION OF THE PREFERRED EMBODIMENT

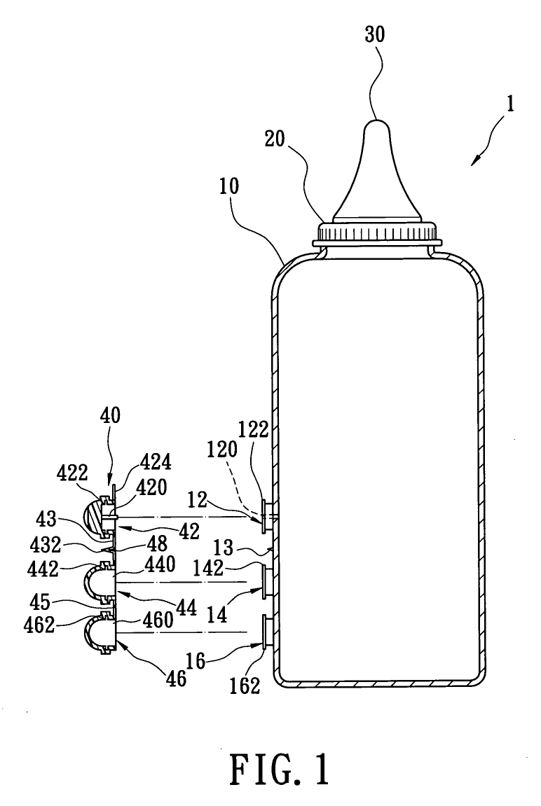

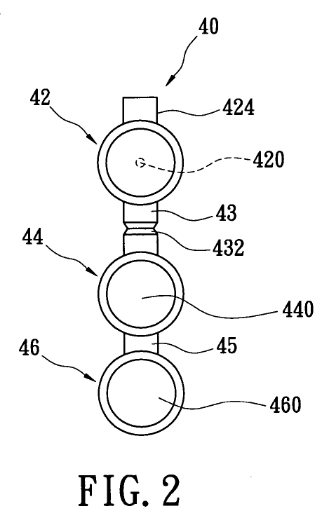

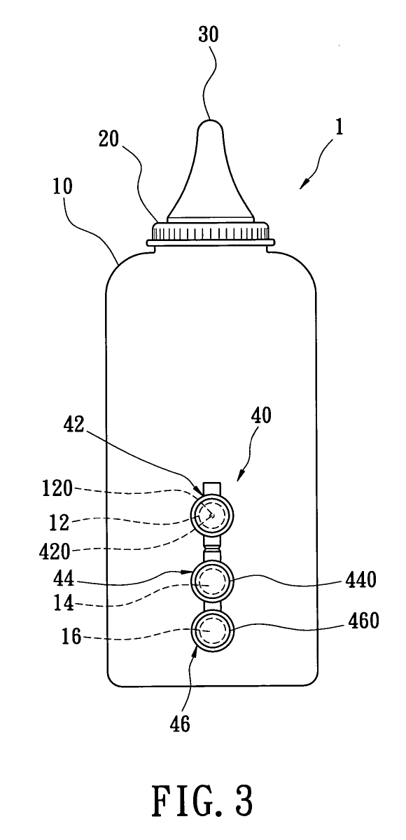

Referring to FIGS. 1 to 3, the present invention mainly provides a ventilated baby bottle 1 having a vent hole 120 with a diameter of 1.0-1.5 mm, which is formed in a bottle portion thereof. When baby nurses the nipple, only the vent hole 120 needs to be opened to establish a pressure balance inside/outside the ventilated baby bottle. The present invention can avoid a negative pressure condition in the baby bottle during nursing, so that baby does not laborious suck to ingest milk. Therefore, the baby is not discouraged from nursing.

The ventilated baby bottle 1 has a bottle portion 10, a nipple ring 20, a nipple 30, and at least one peripheral cover 40. The bottle portion 10 is formed with at least one penetrating vent hole 120. In this embodiment, the nipple 30 is fixed on a top end of the bottle portion 10 via the nipple ring 20. The peripheral cover 40 has two ends; one end is fixed on the bottle portion 10 to avoid falling down, and the other end is formed with a sealing cap 42. The sealing cap 42 is formed with a sealing post 420 therein, and the sealing post 420 is movably inserted in the vent hole 120. The peripheral cover 40 basically is made of a heatproof, easily washed, and non-deteriorating material.

Because the bottle portion of the baby bottle usually has a thin wall, in the preferred embodiment, the bottle portion 10 includes a ventilated protrusion 12, and the vent hole 120 penetrates through the ventilated protrusion 12. The sealing cap 42 is concave and movably covers the ventilated protrusion 12. If the wall of the bottle portion is thicker, it can be formed with the vent hole 120 only.

To avoid loosening the sealing cap 42 from the bottle portion 10, the ventilated protrusion 12 protrudes with a fixing ring 122 from a periphery thereof. An inner wall of the sealing cap 42 is concave with a fixing groove 422 corresponding to the fixing ring 122 of the ventilated protrusion 12 to enhance the fixing force thereof. The sealing cap 42 further has a tab 424 protruding from an edge thereof for convenient holding by a mother or a nurse.

In this embodiment, the vent hole 120 is formed with a diameter of 1.0-1.5 mm and defines a long and thin channel, which is enough to balance the pressure difference inside/outside the baby bottle. If the mother or nurse neglects to cover the vent hole of the baby bottle, the milk will not flow out continually from the vent hole 120 because of the atmospheric pressure. The vent hole is formed preferably under one-third height of the bottle portion from the bottom. The position can allow outside air to flow in and is not covered by the milk.

For fixing the peripheral cover 40 on the bottle portion 10, the peripheral cover 40 further has a flexible link plate 43 and a fixing cap. The link plate 43 is connected with the sealing cap 42 and the fixing cap 44 is connected with the link plate 43 and fixed on the bottle portion 10. The fixing cap 44 can be adhered on the bottle portion 10. In this preferred embodiment, the bottle portion 10 further protrudes with a fixing protrusion 14 adjacent to the ventilated protrusion 12, and the fixing cap 44 is concave with a fixing cavity 440 for receiving the fixing protrusion 14. In this embodiment, the link plate 43 is formed with a bending portion 432 for conveniently lifting the sealing cap 42, and the bottle portion 10 protrudes with a rib 13 corresponding to the bending portion 432.

For enhancing the fixing force, the fixing protrusion 14 includes a fixing ring 142 protruding from a periphery thereof, and an inside wall of the fixing cap 44 is concave with a fixing groove 142 corresponding to the fixing ring 142 of the fixing protrusion 14.

For preventing the fixing cap 44 from rotating on the fixing protrusion 14, the peripheral cover 40 has a second link plate 45 and a second fixing cap 46. The second link plate 45 is connected with the fixing cap 44, and the second fixing cap 46 is connected with the second link plate 45 and fixed on the bottle portion 10.

For enhancing the fixing force of the second fixing cap 46, the bottle portion 10 includes a second fixing protrusion 16, and the second fixing cap 46 is concave with a fixing cavity 460 for receiving the second fixing protrusion 16. The second fixing protrusion 16 includes a fixing ring 162 protruding from a periphery thereof, and an inside wall of the second fixing cap 46 is concave with a fixing groove 462 corresponding to the fixing ring 162 of the second fixing protrusion 16.

A summary of the characteristics and advantages of the ventilated baby bottle is as follows:

1. The ventilated baby bottle of the present invention really balances the pressure inside/outside the baby bottle. A baby does not laboriously suck milk, which is especially beneficial to newborn and premature infants.

2. The ventilated baby bottle of the present invention does not discourage a baby from nursing, and does not promote excessive ingestion of air, thus reducing abdominal distention.

3. The ventilated baby bottle of the present invention has a ventilated structure that is easy to wash, and effectively avoids accumulating milk residue.

4. The ventilated baby bottle of the present invention can solve the problem of expanding when hot and shrinking when cold of “+-type” and “Y-type” nipples while feeding a baby, and effectively avoids discomfort to baby effectively.

Although the present invention has been described with reference to the preferred embodiments thereof, it will be understood that the invention is not limited to the details thereof Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A ventilated baby bottle, comprising:
a bottle portion, having a ventilated protrusion protruding outside therefrom, and a vent hole penetrating through the ventilated protrusion;
a nipple, disposed on a top end of the bottle portion; and
a peripheral cover, having two ends, one end disposed on the bottle portion, and another end having a sealing cap movably covering the ventilated protrusion, wherein the sealing cap is formed with a sealing post movably inserted in the vent hole.

2. The ventilated baby bottle as in claim 1, wherein the ventilated protrusion has a fixing ring protruding from a periphery thereof, and wherein an inner wall of the sealing cap is concave with a fixing groove corresponding to the fixing ring of the ventilated protrusion.

3. The ventilated baby bottle as in claim 1, further comprising a tab protruding from an edge of the sealing cap for conveniently holding.

4. The ventilated baby bottle as in claim 1, wherein the peripheral cover further has a flexible link plate connected with the sealing cap, and a fixing cap connecting with the link plate and fixed on the bottle portion.

5. The ventilated baby bottle as in claim 1, wherein the bottle portion further comprises a fixing protrusion adjacent to the ventilated protrusion, and wherein the fixing cap is concave with a fixing cavity for receiving the fixing protrusion.

6. The ventilated baby bottle as in claim 5, wherein the fixing protrusion has a fixing ring protruding from a periphery thereof, and an inside wall of the fixing cap is concave with a fixing groove corresponding to the fixing ring of the fixing protrusion.

7. The ventilated baby bottle as in claim 5, wherein the peripheral cover has a second link plate connecting with the fixing cap, and a second fixing cap connecting with the second link plate and fixed on the bottle portion.

8. The ventilated baby bottle as in claim 7, wherein the bottle portion has a second fixing protrusion, and wherein the second fixing cap is concave with a fixing cavity for receiving the second fixing protrusion.

9. The ventilated baby bottle as in claim 8, wherein the second fixing protrusion has a fixing ring protruding from a periphery thereof, and an inside wall of the second fixing cap is concave with a fixing groove corresponding to the fixing ring of the second fixing protrusion.
